(19) United States
(12) Patent Application Publication
(10) Pub. No.: US 2009/0039267 A1
(43) Pub. Date: Feb. 12, 2009

(54) Reflector module for a photometric gas sensor

(76) Inventors: Michael Arndt, Reutlingen (DE); Gerd Lorenz, Reutlingen (DE); Johann Wehrmann, Balingen (DE); Ronny Ludwig, Reutlingen (DE); Hans Lubik, Bodelshausen (DE); Thomas Sperlich, Reutlingen (DE); Vincent Thominet, Morges (CH); Maximilian Sauer, Stuttgart (DE)

Correspondence Address: KENYON & KENYON LLP, ONE BROADWAY, NEW YORK, NY, 10004, US

(21) Appl. No.: 11/660,121

(22) PCT Filed: Jul. 14, 2005
(86) PCT No.: PCT/EP2005/053393

§ 371 Date: Oct. 16, 2008

(30) Foreign Application Priority Data
Sep. 13, 2004 (DE) 102004044145.6

(51) Int. Cl. G01J 5/08

(52) U.S. Cl. 250/353

(57) ABSTRACT

The invention relates to a photometric gas sensor containing at least
an infrared radiation source;
a first reflector for deflecting to a second reflector an infrared radiation coming from an infrared radiation source;
a second reflector for deflecting to an infrared detector the radiation coming from the first reflector; and
an infrared detector.

### FIELD OF THE INVENTION

The present invention relates to a photometric gas sensor for ascertaining a gas concentration.

### BACKGROUND INFORMATION

In analytical gas sensor apparatus, a distinction is made between chemical and physical sensors. Whereas chemical gas sensors are constructed with chemical indicators such as variable-resistance pastes, physical sensors function on the basis of spectroscopy (photometry). A radiation (in particular in the infrared wavelength region) from one or more radiation sources is directed via a so-called absorption path to a detector element that converts the arriving radiation intensity into electrical voltage and current. To obtain the greatest possible signal swing for the arriving radiant power, the radiation emitted from the source must be sent to the detector element in the most direct and focused fashion possible. This can be achieved either by the fact that the radiation source and the detector element are directly opposite one another (“face to face” configuration), or with the use of reflector modules that deflect and additionally focus the radiation.

German Published Patent Application No. DE 102 43 014 discloses an apparatus for detecting radiation signals and an apparatus for measuring the concentration of a substance. Here a first detector and a second detector are provided on a first chip, and a first filter and a second filter are provided on a second chip, the first chip and second chip being joined to one another in hermetically sealed fashion.

### SUMMARY OF THE INVENTION

The present invention relates to a photometric gas sensor for ascertaining a gas concentration or the concentration value of a gas, or a variable describing a gas concentration, containing
an infrared radiation source;
a first reflector for deflecting to a second reflector an infrared radiation coming from an infrared radiation source;
a second reflector for deflecting to an infrared detector the radiation coming from the first reflector; and
an infrared detector.

The use of reflectors makes possible a particularly compact design for the gas sensor.

An advantageous embodiment of the invention is characterized in that the first and the second reflector
are made up substantially of plastic and are built into a housing constituent made of plastic; or
are part of a housing constituent made of plastic.

The use of plastic constituents makes possible an economical configuration.

An advantageous embodiment of the invention is characterized in that the first and the second reflector are embodied as mirrored surfaces of the plastic.

An advantageous embodiment of the invention is characterized in that the first and the second reflector
are made up substantially of metal and are built into a housing constituent made of metal; or
are part of a housing constituent made of metal.

An advantageous embodiment of the invention is characterized in that the infrared radiation source and the infrared detector are mounted on a common circuit board.

An advantageous embodiment of the invention is characterized in that the housing constituent is the cover of the sensor.

Integration of the reflectors into the cover yields a particularly compact design.

An advantageous embodiment of the invention is characterized in that the cover exhibits at least one passthrough openings through which the gas can flow into the interior of the gas sensor.

An advantageous embodiment of the invention is characterized in that the first reflector and the second reflector are disposed in such a way that the radiation direction of the infrared radiation deflected from the first reflector to the second reflector is substantially parallel to the surface of the circuit board.

An advantageous embodiment of the invention is characterized in that
two infrared detectors are present, or an infrared detector having two sensor elements is present;
the second reflector is made up of two sub-reflectors that divide the radiation coming from the first reflector into two sub-beams going in different directions;
the two sub-reflectors are disposed so that each of the two sub-beams strikes a different one of the two infrared detectors.

The use of a second infrared detector makes a comparative measurement possible. The use of a second infrared detector also makes possible, instead of a comparative measurement, measurement of the concentration of a second or different gas.

An advantageous embodiment of the invention is characterized in that
the second reflector is made up of two reflectors or sub-reflectors disposed next to one another,
and is disposed in such a way that the radiation coming from the first reflector strikes at the boundary between both sub-reflectors, so that a portion of the radiation strikes each of the two sub-reflectors.

An advantageous embodiment of the invention is characterized in that receptacles for mounting the infrared source and the infrared detector are mounted on the housing constituent. This allows very precise placement of the constituents relative to one another.

An advantageous embodiment of the invention is characterized in that the receptacles are guides.

### BRIEF DESCRIPTION OF THE DRAWINGS

The drawings are made up of FIGS. 1 to 5.

FIG. 1 shows an exterior view of a first embodiment of the reflector module.

FIG. 2 shows a view into the interior of a first embodiment of the reflector module.

FIG. 3 shows an exterior view of a second embodiment of the reflector module.

FIG. 4 shows a view into the interior of a second embodiment of the reflector module.

FIG. 5 shows a section showing receptacles for the radiation source and the detector.

### DETAILED DESCRIPTION OF THE DRAWINGS

The invention serves to optimally focus the radiant power of a radiation source with the aid of one or more optical reflector modules, and direct it via the absorption path to the detector element. Two or three reflectors are used. These reflectors can be made up of one continuous module or of individual optical elements. A distinction is made here between a closed reflector module and a so-called “open-path” module. With the open-path configuration, the center reflector module is omitted and is replaced by the open beam path thereby created. This optical reflector module can be used for a photometric gas sensor. FIGS. 1, 2, 3, and 4 depict two embodiments of the reflector module. The module is configured, in terms of the beam pathway from radiation source a to radiation detector b, in such a way that
reflector R1 focuses the radiation received from radiation source a and directs it, parallel to bottom part 53 (on which the radiation source and the radiation receiver are mounted), to reflector R3; and
reflector R3 further focuses the radiation, and directs it vertically downward to the detector or detectors.

Two embodiments for the reflectors are depicted in the Figures:

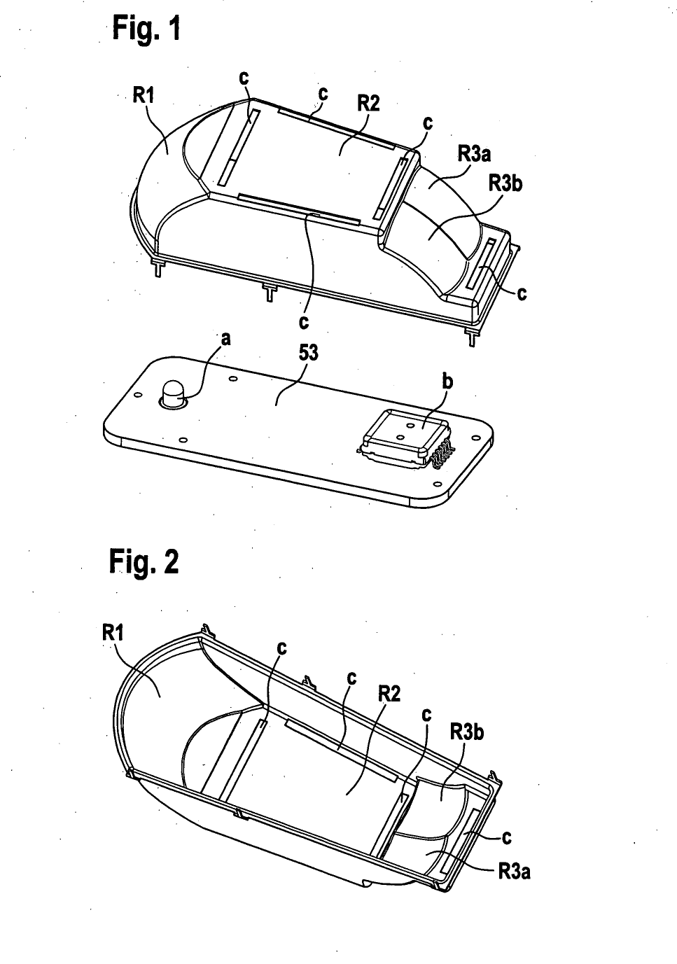

FIG. 1 and FIG. 2 show an embodiment as a deep-drawn metal structure;

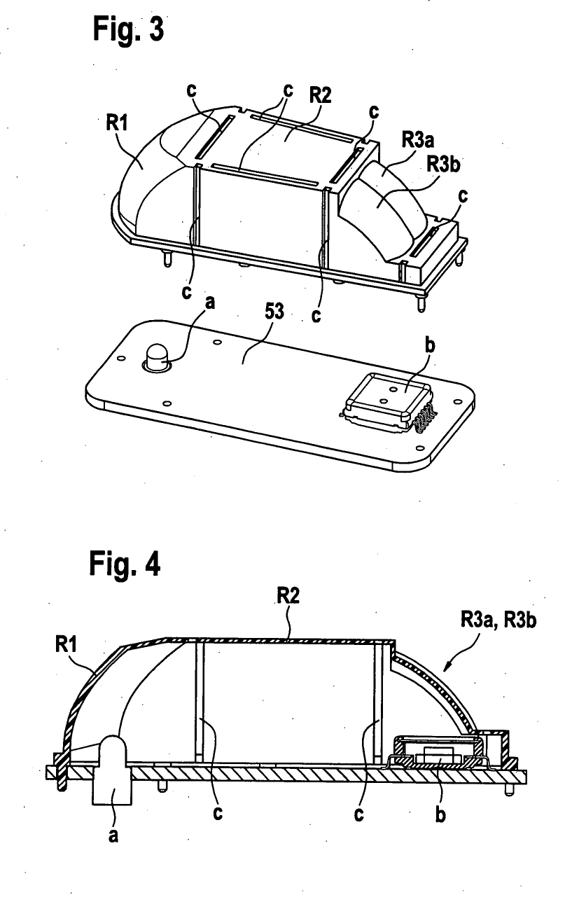

FIG. 3 and FIG. 4 show an embodiment made of plastic.

For each of these two embodiments, a configuration in “closed-path” and “open-path” fashion is possible.

### Closed-Path Configuration

This configuration is depicted in FIGS. 1 to 4. This involves a closed reflector module below which radiation source a and detector element b are located. The reflector module contains:
reflector R1 for focusing and deflecting the beam pathway of the radiation source;
component R2, which represents a cover for the reflector module; and
one or two sub-reflectors R3a and R3b that focus and deflect the radiation onto the detector element or elements.

With this configuration, the reflector module is a single component that contains components R1, R2, and R3.

The reflector module can be constructed from an internally mirrored plastic or can be embodied as a metal structure. The metal structure can be produced, for example, by a deep-drawing process. Delivery of the gas for analysis into the interior of the reflector module is enabled by slots c in component R2.

Component or constituent R2 can also, for example, be used as electrical shielding to ensure favorable electromagnetic compatibility (EMC) properties.

### Open-Path Configuration

In the open-path configuration, component R2 is omitted. As a result, the region of plane-parallel beam guidance between reflector part R1 and reflector part R3 is open. The embodiment of reflectors R1 and R3 remains unchanged with this configuration; they can be embodied as one continuous module or as individual reflectors. The elimination of reflector part R2 creates an open system in which the gas to be measured can be sensed directly in the ambient atmosphere. The advantage of this configuration is the more rapid sensing of the measured gas in the ambient atmosphere. This is made possible by the absence of a housing part through which the measured gas must first diffuse.

The same reflectors at the same spacings can be used for both the open-path configuration and the closed-path configuration. Both configurations are independent of the optical bandwidth of the detector element and the frequency range of the infrared radiation, and can therefore be used universally for all photometric gas sensors of the present design.

A further critical factor for the performance capabilities of an optical sensor system is positioning of the detector, reflector, and radiation source as exactly as possible with respect to one another. This is the only way to ensure that the largest possible proportion of the radiant power is delivered to the detector, thus resulting in maximum signal yield. This means minimizing the tolerance chain from radiation source to reflector module to detector, which can be achieved by design measures in terms of the reflector. For this purpose, receptacles are provided in the reflector which ensure alignment of the lamp and the detector with regard to the reflector module or housing constituent upon assembly. The reflector's production tolerances are therefore the only ones relevant to assembly of the overall system. This has the following two advantages:
The beam directed from the second reflector onto the sensor element can be more strongly focused, since the alignment of the sensor element and detector onto the reflector means that the position of the sensor relative to the reflector is defined. The smaller focus spot thereby made possible results in a higher radiation density, which generates a larger absolute electrical signal in the sensor element.
Assembly of the three constituents (reflector module, detector, and radiation source) is made substantially easier by the exact positioning with respect to one another.
The possibility that the spot of focused infrared radiation might not reach the sensor element, or might be located alongside the light-sensitive portion of the sensor element, is avoided.

Upon assembly of the three constituents on the circuit board, the reflector is secured on the circuit board via corresponding receptacles. The radiation source and the detector are then positioned on the circuit board relative to the reflector. This ensures that all the tolerances that would occur in a context of separate assembly are minimized.

One possible procedure for installing the three constituents (reflector, detector, and radiation source) is described below:
Push the detector into one receptacle of the reflector.
Install the reflector-detector unit, the reflector being, for example, clinched, and the detector being soldered using surface mounted device (SMD) technology.
Reverse-install the radiation source, the radiation source being introduced through an over-tolerance orifice into a guide of the reflector, and then being soldered using SMD technology.

As an alternative to this, the circuit board can have the detector installed on it first. The reflector and lamp are then aligned by way of the immovably integrated detector. As described above, alignment of all three constituents is of course also possible by way of the radiation source as reference. In this case the radiation source can be installed from above. In both cases, however, the alignment of all three constituents must always be ensured by way of appropriate design features on the reflector.

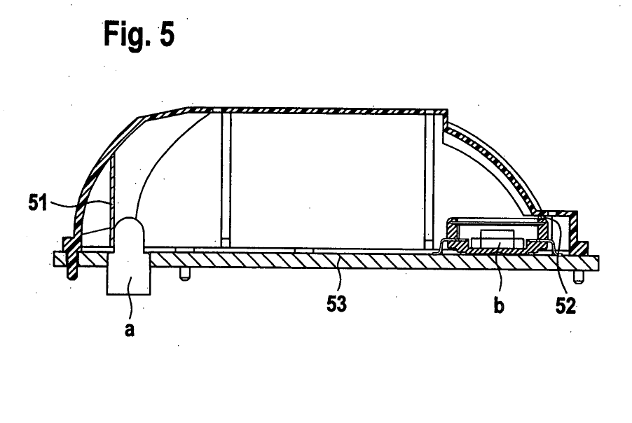

FIG. 5 depicts receptacles 51 and 52 for lamp a and detector element b, respectively. In this exemplary embodiment, 51 is a guide for lamp a (i.e. lamp guide), and 52 is a guide for reflector b (i.e. reflector guide). As in FIGS. 1 and 3, 53 designates the circuit board.

The second reflector can also encompass two adjacent sub-reflectors R3a and R3b. The focal point of the infrared beam arriving from the first reflector is incident onto the boundary line between sub-reflectors R3a and R3b. The halves of the focal point striking R3a and R3b are deflected in two different directions. Infrared detector b is embodied as a two-channel detector, i.e. having a measurement channel and a reference channel. One of the two sub-beams strikes the sensor element associated with the measurement channel, and the other sub-beam strikes the sensor element associated with the reference channel. The two sensor elements can be implemented, for example, as adjacent chips in a common housing, or even next to one another on one chip.

Because of its small overall size, the gas sensor is suitable for use in a motor vehicle, in particular for ascertaining the carbon dioxide concentration of the air in the motor vehicle's interior.

1-12. (canceled)

13. A photometric gas sensor for ascertaining a gas concentration, comprising:
an infrared radiation source;
an infrared detector;
a first reflector;
a second reflector, the first reflector deflecting to the second reflector an infrared radiation coming from the infrared radiation source, and the second reflector deflecting to the infrared detector the infrared radiation coming from the first reflector.

14. The photometric gas sensor as recited in claim 13, further comprising:
a plastic housing, wherein the first reflector and the second reflector are made up substantially of plastic, and wherein one of:
the first reflector and the second reflector are built into the housing, and the first reflector and the second reflector are part of the housing.

15. The photometric gas sensor as recited in claim 14, wherein the first reflector and the second reflector are embodied as mirrored surfaces of the plastic.

16. The photometric gas sensor as recited in claim 13, further comprising:
a metal housing, wherein the first reflector and the second reflector are made up substantially of metal, and wherein one of:
the first reflector and the second reflector are built into the housing, and the first reflector and the second reflector are part of the housing.

17. The photometric gas sensor as recited in claim 13, further comprising:
a common circuit on which the infrared radiation source and the infrared detector are mounted.

18. The photometric gas sensor as recited in claim 14, wherein the plastic housing is a cover of the sensor.

19. The photometric gas sensor as recited in claim 16, wherein the metal housing is a cover of the sensor.

20. The photometric gas sensor as recited in claim 19, wherein the cover has at least one passthrough opening through which a gas can flow into an interior of the gas sensor.

21. The photometric gas sensor as recited in claim 17, wherein:
the first reflector and the second reflector are disposed in such a way that a radiation direction of the infrared radiation deflected from the first reflector to the second reflector is substantially parallel to a surface of the common circuit board.

22. The photometric gas sensor as recited in claim 13, wherein:
the infrared detector includes a plurality of infrared sensor elements,
the second reflector includes two sub-reflectors that divide the infrared radiation coming from the first reflector into two sub-beams going in different directions, and
the two sub-reflectors are disposed so that each of the two sub-beams strikes a different one of the two infrared sensor elements.

23. The photometric gas sensor as recited in claim 13, wherein:
the second reflector includes two sub-reflectors disposed next to one another, and
the second reflector is disposed in such a way that the infrared radiation coming from the first reflector strikes at a boundary between the two sub-reflectors, so that a portion of the infrared radiation strikes each of the two sub-reflectors.

24. The photometric gas sensor as recited in claim 14, further comprising:
receptacles mounted or the plastic housing and on which the infrared source and the infrared detector are mounted.

25. The photometric gas sensor as recited in claim 16, further comprising:
receptacles mounted on the metal housing and on which the infrared source and the infrared detector are mounted.

26. The photometric gas sensor as recited in claim 24, wherein the receptacles are guides.

27. The photometric gas sensor as recited in claim 25, wherein the receptacles are guides.
